(19) United States
(12) Patent Application Publication
(10) Pub. No.: US 2020/0097976 A1
(43) Pub. Date: Mar. 26, 2020

(54) ADVANCED FINGER BIOMETRIC PURCHASING

(71) Applicant: Colin Nickolas Hause, Lakewood, CO (US)

(72) Inventor: Colin Nickolas Hause, Lakewood, CO (US)

(21) Appl. No.: 16/138,739

(22) Filed: Sep. 21, 2018

(51) Int. Cl. G06Q 20/40; G07F 7/08; G06K 9/00

(52) U.S. Cl. CPC G06Q 20/40145; G07F 7/088; G06K 9/00087; G06K 2009/00939; G06K 9/00885; G06K 2009/00932; G06K 9/00382

(57) ABSTRACT

A payment terminal such as is used for scanning credit cards and debit cards but which is instead/also capable of deep finger scans, NOT limited to superficial finger scans (such as finger prints), for advanced multi-factor purchases with a single financial instrument: the finger. Advanced deep finger scans can detect several factors: finger print, pulse rate, vein structure and bone structure. Thus at the checkout stand, a customer will be presented with an advanced finger scanner which may superficially look like a finger print scanner but which in fact is capable of determining all of the values of the items above. The advanced finger scanner may access various databases and thence the financial settlement (banking) system to cause payment to be processed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to POS stations (cash registers) and specifically to purchase terminals (similar to credit card readers) for payment while making a purchase.

### STATEMENT REGARDING FEDERALLY FUNDED RESEARCH

This invention was not made under contract with an agency of the US Government, nor by any agency of the US Government.

### BACKGROUND OF THE INVENTION

The typical POS (POINT OF SALE) Station or cash register typically is equipped with a cash drawer, a CPU, simple programming, a large display for the clerk and a small one for the customer, and finally a credit card purchase transaction device. The present invention is focused on improving and replacing this credit card terminal, in the immediate term for improvement but in the long term for replacement.

The typical credit card reader is a small box having thereon a credit card magnetic stripe reader, a credit card chip reader, a numeric-only keypad for the entry of PINS and the like, and a display for signatures, small advertisements, or simply choices like receiving cash back after a debit card purchase.

The typical credit card terminal thus accepts four forms of input data: magnetic stripe swipes, chip reading, PINS, and signatures. Each of these may be considered a single security factor, when a chip and PIN are combined, it is considered to be “multi-factor” security. Note that the typical signature is not usually considered security at all. Multi-factor security is a desirable goal in various areas, in particular, in the present field of POS terminals.

While a single card, with a short PIN memorized, can be used successfully to carry out purchases, it would be better to provide a terminal which does not require any card and yet provides extremely upgraded levels of multi-factor security, including methods of security not presently commonly used with purchases and not generally known at all.

One common attempt to provide additional security is the use of a finger-print or retinal scanner. This method is so common that low cost telephones, mobile devices and PCs may now have finger-print scanners to access the device (security), which device then has apps or applications allowing purchases (purchase enablement). Thus fingerprint scanners are known.

In general, fingerprint scanners actually do have some shortcomings. Not only are they somewhat temperamental, returning many false negatives to frustrated phone owners, but they also are usually single-factor security, or two factor if a PIN is employed with a thumb print. In addition, there is the negative image in the public mind from gory Hollywood scenes in which cut-off fingers or cut-out eyeballs are used to enter secure installations. For these and other more technical reasons, finger-print security is still relatively less common than the ancient technology of lock and key.

Finger-print purchasing, known in the art, is available but generally considered unacceptable. One exception to the unpopularity of fingerprint purchasing would be ApplePay®, for which numerous applications have been filed, for example, US Patent Application No. 20150161587, in the name of Khan et al, published Jun. 11, 2015. Such patents of course relate to fingerprint access to a personal mobile device, which personal mobile device is then used for purchasing. Rather than suggesting better scanning of a human finger in a public/merchant context for direct initiation of a financial transaction, patents like the ApplePay® system propose electronic/business method solutions such as the usage of near field communication for security.

Typically, as of 2018, an Apple iPhone® or some other mobile device fingerprint-scanner might scan half a dozen biometric points on a person's fingerprint to open their phone. Even law enforcement might scan only 8 biometric points on a person's fingerprint for purposes of convictions for major crimes or identity. In either case, ALL of the points are strictly fingerprint based data points.

In general, PRIOR ART purchases via credit/debit card follow a well known pattern: the card has a code number on the magnetic stripe or chip, this is read by the card reader, the user then inputs a PIN or mail code (ZIP code), and the information is sent off as both identification of the card, and as hypothetical security offered by having a “long” (16 digit, 20 digit, etc) card number. It is worth noting that in general, computer passwords which have a much longer alphabet (36 or more letters and numbers as opposed to just 10 numerals) are considered to be easily crackable unless they have as many as 24 digits or more. Thus the old fashioned mag-stripe number of a credit card (conveniently printed with 16 digits on one side of the card and 3 more on the other as a CVV code, or more if the ZIP code or expiration dates are considered security digits) are fairly low security even before the risk of loss enters the picture.

This combination of identity, security and authorization is then sent via the banking system between the merchant bank, a merchant processor, possible other newer forms of handlers and gateways, and eventually a query is made to a credit card issuing bank or a debit card issuing bank. A confirmation that the purchase is authorized is returned to the POS station, the money is transferred from the card account to the merchant's account, and receipts (if any) are printed, etc.

The system has numerous disadvantages. The card may be lost (and thus unavailable for use when needed), stolen, damaged, and so on. The numbers can usually be “skimmed” without highly sophisticated equipment, the card has to be carried and so on and so forth.

Obviously one other aspect of the financial system is simply identity: is the person holding the card really the legal card holder? Most merchants simply don't care: checking ID with the card is thing of the past in most places. The usual form of ID is either an internal or external passport, or a government issued ID which is universally accepted in a given country, for example, the typical US merchant accepts a driver's license as proof of ID if they actually bother to check ID at all.

Thus one problem with some factors of security, such as ID cards or signatures, is simply that no one is checking them anymore.

One problem with PIN codes is that they are often forgotten or not even asked for on small purchases.

One problem with most purchase devices (such as a credit card or fingerprint) is that they have fairly low levels of actual security against brute force attacks. One exemplary way to measure security strength of a purchase device (falsely equating the purchase device to a password) is to measure the entropy provided by the device. Every digit of the arabic numerals provides an entropy of just over 3 bits per letter, while the case sensitive alphanumeric characters provide an entropy of around 6 bits per letter, making them twice as secure for the same number of digits. It is believed that various advanced techniques allow brute force attacks on up to 128 bits of entropy. By this measurement a credit card number having 16 digits in the card number plus 3 in the CVV code, plus 4 for the expiration date (which digits are actually easily guessable) would have only about 60 to 80 bits of entropy, a rather surprisingly LOW level of protection. (This technique is fundamentally flawed of course because purchase devices are not passwords.)

It would be preferable to automate each and every factor in a multi-factor security system

so that no factor is ignored by harried clerks, no factor is forgotten by busy consumers who already have too many PINS to memorize and only so many family members birth dates available to provide deeply secure PINS, and also to allow each factor to be so difficult to forge or copy that false purchases may be nearly eliminated.

The present invention concerns NOT checking ID but rather the authorization of purchases. However, these two different activities are often confused with one another so it bears a bit of discussion: a typical credit card number in usage today is offered as proof of solvency, not as proof of identity. Many credit cards are simply lent to family members and despite the fact that the names are different, are routinely accepted because no one checks ID, just credit. In a token based system such as Applepay®, a fingerprint provides access to the mobile device having the token thereon, then the token serves as authorization, similar to a credit card.

Thus the present invention, although it deals with finger scanning, is not about identity determination.

The present invention is about purchases, in particular, establishment of credit to make a purchase.

It would be preferable to provide a multi-factor advanced finger scan POS terminal, which need not even rely upon fingerprints, so that consumers would always be “carrying their credit card”.

It would be preferable to provide a device which does not allow of loss or theft, nor require memorization of PINS (but which allows optional usage of PINS, finger prints, etc).

It would be preferable to provide a way to make purchases without presenting any physical token at all.

The present invention does not concern fingerprint security (for computer, phone or door access), for example, the fingerprint scanners on Apple® products.

This invention also does NOT even deal with finger print purchasing (with single factor security or with the addition of a PIN).

The present invention teaches that multi-factor, relying upon NON-finger-print, advanced scanning of fingers, may be used to activate purchases in the same manner as a credit card but with true multi-factor security (of which a finger print would be merely one optional factor). This is in contrast to use of advanced finger scanning for entry to doors, telephones, computers and so on. Fingerprints may easily be used as an option, but are not necessary.

The present invention may use 300 or more biometric points, of several different types, not just fingerprints, to provide an extremely high level of purchase security, especially when compared to the 16 to 28 digits of a typical credit card purchase.

Examples of advanced finger scanning devices/deep scanning devices may be found at:

https://www.qualcomm.com/solutions/mobile-computing/features/security/fingerprint-sensors

and http://www.sonavation.com/sonavation-ultrasound-biometric-technology/both of which show that physical deep scanning of fingers is possible, but both of which show it for security purposes rather than actual direct purchase initiation.

Thus for example one could combine ApplePay® with the deep scanners shown above, thus obtaining a NON-purchase use of the deep scan: one would use the deepscan for security (to access the telephone/tablet) and then use the telephone/tablet as the token or credit card number to make a purchase.

Obviously such a combination would be clumsy and needlessly complex. The present invention teaches the finger itself may be sufficient to make the purchase.

### SUMMARY OF THE INVENTION

### General Summary

The present invention teaches a payment terminal such as is used for scanning credit cards and debit cards but which is instead/also capable of deep finger scans, NOT limited to superficial finger scans (such as finger prints), for advanced multi-factor purchases with a single financial instrument: the finger. The present invention further teaches a payment terminal which need not have credit card/debit card functionality but simply uses advanced deep scanning of fingers for payment authorization, not for identity.

Advanced deep finger scans can now detect at least the following four factors: finger print, pulse rate, vein structure and bone structure. Thus at the checkout stand, a customer will be presented with an advanced finger scanner which may superficially look like a finger print scanner but which in fact is capable of determining all of the values of the items above.

Each of these items can be encoded into a numerical value and then encrypted, transmitted to a verifier, and then used instead of a credit card number for purchase authorization.

Note that the “pulse” value can simply be used as proof-of-life, that is, to verify that the finger is still attached, thus rendering such fantastic gory scenarios as the use of cut-off fingers a thing of the past.

The present device may tie into the banking system to then carry out the transaction.

### SUMMARY IN REFERENCE TO CLAIMS

It is therefore another aspect, advantage, objective and embodiment of the invention, in addition to those discussed previously, to provide an improved point-of-sale station, having a payment terminal, a first operative connection from the payment terminal to the point-of-sale station, and further having a second operative connection to a financial payment processing network, for use by customers having fingers having therein finger bone structure, veins, a pulse, and finger prints, wherein the improvement comprises:

an advanced finger scanner, the advanced finger scanner operative to scan such finger bone structure, encrypt the scan, and transmit the encrypted scan via the second operative connection to such financial payment processing network.

It is therefore another aspect, advantage, objective and embodiment of the invention, in addition to those discussed previously, to provide an improved point-of-sale station, having a payment terminal, a first operative connection from the payment terminal to the point-of-sale station, and further having a second operative connection to a financial payment processing network, for use by customers having fingers having therein finger bone structure, veins, a pulse, and finger prints, wherein the improvement comprises:

an advanced finger scanner, the advanced finger scanner operative to scan such finger veins, encrypt the finger vein scan, and transmit the encrypted finger vein scan via the second operative connection to such financial payment processing network.

It is therefore another aspect, advantage, objective and embodiment of the invention, in addition to those discussed previously, to provide an improved point-of-sale station, having a payment terminal, a first operative connection from the payment terminal to the point-of-sale station, and further having a second operative connection to a financial payment processing network, for use by customers having fingers having therein finger bone structure, veins, a pulse, and finger prints, wherein the improvement comprises:

an advanced finger scanner, the advanced finger scanner operative to scan such finger veins, scan such finger bone structure, encrypt the finger vein scan and the finger bone structure scan, and transmit the encrypted scans via the second operative connection to such financial payment processing network.

It is therefore another aspect, advantage, objective and embodiment of the invention, in addition to those discussed previously, to provide an improved point-of-sale station, further comprising:

the advanced finger scanner further operative to determine the existence of such pulse, flag the existence of such pulse, and transmit the pulse existence flag, along with the encrypted finger vein scan and the encrypted finger bone structure scan via the second operative connection to such financial payment processing network.

It is therefore another aspect, advantage, objective and embodiment of the invention, in addition to those discussed previously, to provide an improved point-of-sale station, further comprising:

the advanced finger scanner further operative to scan such fingerprint, encrypt the fingerprint scan and transmit the encrypted fingerprint scan, along with the pulse existence flag, the encrypted finger vein scan and the encrypted finger bone structure scan via the second operative connection to such financial payment processing network.

It is therefore another aspect, advantage, objective and embodiment of the invention, in addition to those discussed previously, to provide a point-of-sale station for use with a financial payment processing network, for use by customers having fingers having therein finger bone structure, veins, a pulse, and finger prints, wherein the point-of-sale station comprises:

a payment terminal;

a first operative connection from the payment terminal to the point-of-sale station,

a second operative connection to such financial payment processing network;

the payment terminal operative to initiate a financial payment using such financial payment processing network, by transmitting a first data packet to such financial payment processing network via the first and second operative connections and the point-of-sale station;

the payment terminal having an advanced finger scan scanner operative to determine the existence of such pulse and flag the existence of such pulse;

the advanced finger scanner further operative to scan one member selected from the group consisting of: such finger bone structure, such finger veins, or both, and encrypt the scan;

the payment terminal operative to create the first data packet by combining the encrypted scan and the flag and transmit the first data packet;

whereby the financial payment is initiated.

It is therefore another aspect, advantage, objective and embodiment of the invention, in addition to those discussed previously, to provide a point-of-sale station, wherein the advanced finger scanner is further operative to scan such fingerprint and encrypt the scan;

and wherein the payment terminal is further operative to incorporate into the first data packet the encrypted fingerprint scan.

It is therefore another aspect, advantage, objective and embodiment of the invention, in addition to those discussed previously, to provide an point-of-sale, further comprising:

an advanced finger scan database, having a third operative connection to such financial payment processing network, the advanced finger scan database operative to respond to receipt of the first data packet by verifying that the first data packet matches a first record of the advanced finger scan database;

the first record having at least three parts, a personal information part, a financial information part, and an advanced finger scan record part.

It is therefore yet another aspect, advantage, objective and embodiment of the invention to provide a method of carrying out a financial transaction, without use of a credit or debit card, for use with a financial payment processing network which is responsive to receipt of a data packet to initiate a financial transaction, the method for use by customers having fingers having therein finger bone structure, veins, a pulse, and finger prints, the method comprising the steps of:

providing a point-of-sale station having a payment terminal;

providing a first operative connection from the payment terminal to the point-of-sale station;

providing a second operative connection to such financial payment processing network;

providing an advanced finger scan scanner operative to determine the existence of such pulse and flag the existence of such pulse;

using the advanced finger scanner to scan one member selected from the group consisting of: such finger bone structure, such finger veins, or both;

encrypting the scan and the flag;

creating a first such data packet by combining the encrypted scan and the flag;

transmitting the first such data packet to such financial payment processing network via the second operative connection;

whereby the financial payment is initiated by such financial payment processing network.

It is therefore yet another aspect, advantage, objective and embodiment of the invention to provide a method of carrying out a financial transaction, method of carrying out a financial transaction, wherein the advanced finger scanner is further operative to scan such fingerprint and encrypt the fingerprint scan;

incorporating the fingerprint scan into the first such data packet during creating the first such data packet.

It is therefore yet another aspect, advantage, objective and embodiment of the invention to provide a method of carrying out a financial transaction, method of carrying out a financial transaction, further comprising:

providing an advanced finger scan database, having a third operative connection to such financial payment processing network;

transmitting the first such data packet to the advanced finger scan database;

verifying that the first such data packet matches a first record of the advanced finger scan database;

the first record having at least three parts, a personal information part, a financial information part, and an advanced finger scan record part.

### BRIEF DESCRIPTION OF THE DRAWINGS

FIG. 1 is an orthogonal diagram of an advanced finger scanner in use to make a purchase, with a user finger thereon.

FIG. 2 is an orthogonal diagram of an advanced finger scanner purchase terminal, alone.

FIG. 3 is a frontal view of a POS station showing numeric display, keys, cash drawer, etc, and the back of the advanced finger scanner terminal (which faces toward customers rather than clerks).

FIG. 4 is an advanced finger scan data return, showing the different data which the finger scan returns.

FIG. 5 is an overview structural diagram with data flows which further serves to connect the three following flowcharts (FIGS. 6, 7 and 8).

FIG. 6 is a flowchart of an advanced fingerscan database and the usage thereof.

FIG. 7 is a flowchart of a personal information database and operations during completion of a financial transaction.

FIG. 8 is a flowchart of the operations when the advanced fingerscan is used to complete a financial transaction.

FIG. 9 is a data flow diagram of an alternative embodiment of the invention.

FIG. 9A is a data flow diagram of an alternative embodiment of the invention

### INDEX TO REFERENCE NUMERALS

POS Purchase terminal 2
Base plate 4
Card reader 6
Advanced finger scanner 8
POS Station 10
Connection 12
Connection 14
Finger database 102
Personal database 104
Payment database 106
Pinpad/advanced finger scanner 108
Point of sale station (POS) 110
Banking system 112
Scan finger F100
Encrypt data packet F102
Finger database F104
In database? F106
Clear individual for purchase F108
Enroll in database F110
Confirmation to pinpad F112
Pinpad notifies POS and waits F114
POS connects to personal database F116
POS queries database for specific customer P102
Database retrieves customer data P104
POS requests transaction specific info P106
Database determines if permitted to share P108
Database denies sharing P110
Database shares transaction specific info P112
Can transaction continue? P114
Transaction cancelled P116
POS connects to payment database P118
POS queries financial database for specific
customer S102
Database retrieves customer payment data S104
Database communicates accounts to pinpad S106
Pinpad displays account choices S108
Customer selects account choices S110
POS queries database for funds availability S112
Database queries customer's bank S114
Amount available? S116
Customer selects alternative account S118
POS tells db to process transaction S120
Database requests funds transfer S122
Database notifies POS of payment S124
POS saves transaction info to cloud S126
Transaction completion S128
Data packet 800
Packet ID 802
Bone scan data 804
Bone scan 804′
Vein scan data 806
Vein scan 806′
Print scan data 808
Print scan 808′
Pulse/proof of life data field 810
Pulse/proof of life 810′
Overhead/misc 812
Deep finger scans database 900
Personal data 902
Deep finger scan 906
POS terminal operations 910
Financial system operations 912
Payor account 922
Payee account 924
Deep finger scans database 900A
Personal data 902A
Financial database 904A
Deep finger scan 906A
Pinpad operations 908A
POS terminal operations 910A
Financial system operations 912A
Payor account 922A
Payee account 924A

### DETAILED DESCRIPTION

### Glossary

It is important to distinguish the present invention from identity, ID, computer access, security access and similar systems. Such systems allow an individual to access a computer, a door, a mobile device or the like.

The present system on the other hand is designed to initiate a specific financial transaction: the purchase of a product in a manner similar to a credit card purchase (and in fact optionally using a modified credit card reader, without using a card), but without using any credit or debit card.

As used herein a “payment terminal” is a small device present where a consumer may easily access it at the check out counter, the payment terminal having the capability to accept payments in non-cash form. This includes but is not limited to traditional pinpads, credit card terminals, and so on, but in preferred embodiments it is anticipated that these will be made obsolete by the use of the deep finger scan. The payment terminal may have direct connections (for example via Ethernet) to the POS terminal, to the banking payment system and to some or all of the various databases of the present invention.

As used herein, a “financial transaction” refers to a sale/purchase transaction (since every sale is also a purchase and vice-versa, depending on viewpoint).

Initiating a financial transaction means carrying it out, using the banking system, in a manner similar to use of a debit card or credit card or a numeric token: a data packet is sent to an “issuing” bank or entity (although in this case not a card issuing bank but rather a deep finger scan depository), the transaction is approved, the amount of money available is verified, and the user is given the option of selecting an account from which to make the transaction. The account chosen may be either a deposit account (such as a saving or checking account) or a line of credit (such as a credit card account) and yet in neither case is there any card used. Nor is there any analog to the 15 digit or 16 digit or similar card numbers (with 3 additional digits as a CVV code).

A “deep finger scan” or “advanced finger scan” as used herein is also NOT a fingerprint scan. A fingerprint scan may be an optional addition to the advanced finger scan, and as an additional security factor is thus desirable, but the present invention does not concern fingerprints, especially not as a form of identification. An advanced finger scan as used herein refers to the provision of a scanner which can scan and save or flag the details of an individuals INTERNAL finger structure, specifically including at least one of either the finger bone structure or the finger vein structure. In addition, a deep/advanced finger scan may determine that the finger is alive, thus defeating ridiculous scenarios involving cut-off fingers. This may be by flagging a pulse or other attribute of a living body: capacitance, fluid level and so on. In addition to flagging pulse, the scan may even use the pulse itself as another security factor: the shape of the pulse wave may be a characteristic scanned.

### End Glossary

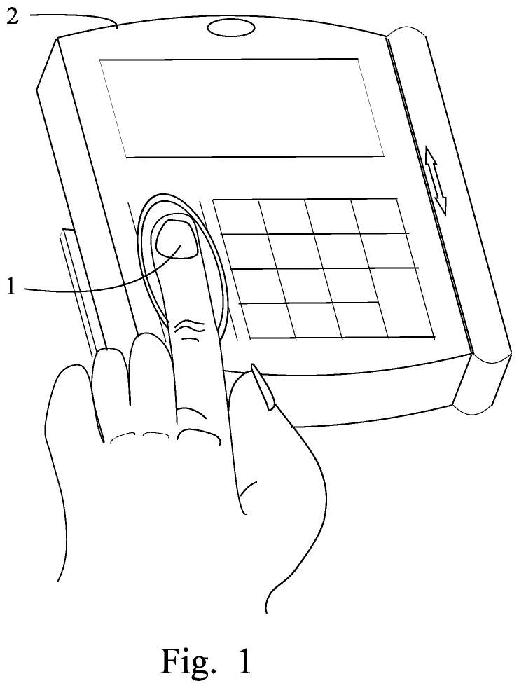

In the presently preferred embodiment and best mode presently contemplated for carrying out the invention, FIG. 1 is an orthogonal diagram of an advanced finger scanner in use to make a purchase, with a user finger thereon. Buyer finger 1 is seen as it is being deep scanned by the POS Purchase terminal/pinpad 2.

In use the advanced/deep scan is quite quick and produces a plethora of information about the user's finger internally: pulse, oxygen level, and so on can all be used (and readings such as these three are very useful for flagging proof-of-life), however, less ephemeral data can also be collected. In particular, scanners on the market such as described above can scan an individuals finger veins within the finger, and even scan the shape of the individual's finger bones. These two measurements are quite convenient as markers. But in the present context, these are not used for identity but rather like credit card numbers, to indicate a financial account for payment.

In addition, the present invention need not even use the more traditional “finger print” for identity or purchase—bearing in mind that systems such as Apple Pay® and the like use finger prints for identity to open up a mobile device (iPhone®, etc) and then use the mobile device to make a purchase from further security information or financial information stored on the mobile device. The present invention may use fingerprints, but need not do so.

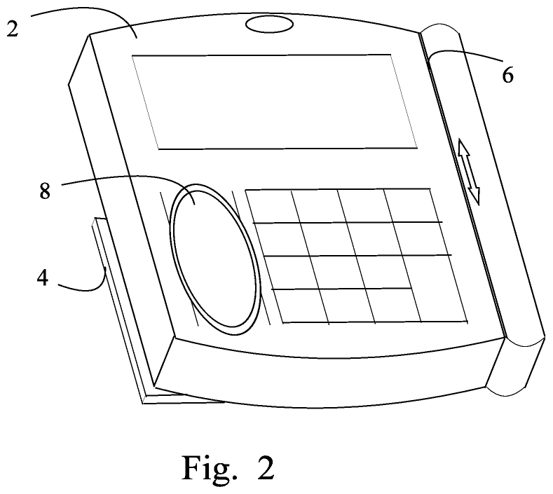

FIG. 2 is an orthogonal diagram of an advanced finger scanner purchase terminal, alone. POS purchase terminal 2 may be seen to be akin to those devices commonly used for credit card transactions. In this case, the device may optionally have a card scanner, however it is anticipated that this is not required.

Base plate 4 may secure the terminal 2 from theft or damage—the base plate 4 may in turn be secured to a rotating post, a countertop, or the like.

Card reader 6 is for a traditional “swipe” of a magnetic card. For security reasons, these are falling out of favor and so chip & pin systems in which the card is inserted and a chip on the card is read are becoming favored: note that the chip reader of the terminal 2 is not visible in these diagrams since it is a small opening on the front side.

In embodiments, the terminal 2 may not have card readers/chip readers 6, when a time comes that credit cards are largely abandoned in favor of advanced scan technology.

Advanced finger scanner 8 may be seen without the user's finger obscuring it, however, this is merely one possible embodiment of the advanced/deep finger scanner. This particular one is optimized to appear to be much like a fingerprint scanner, in order to aid user familiarity with the system, with a ring which lights up when a finger scan is successful and a central pad for the deep sensors and so on. However, the advanced finger scanner 8 may have an optional fingerprint scanning ability but it is NOT a fingerprint scanner.

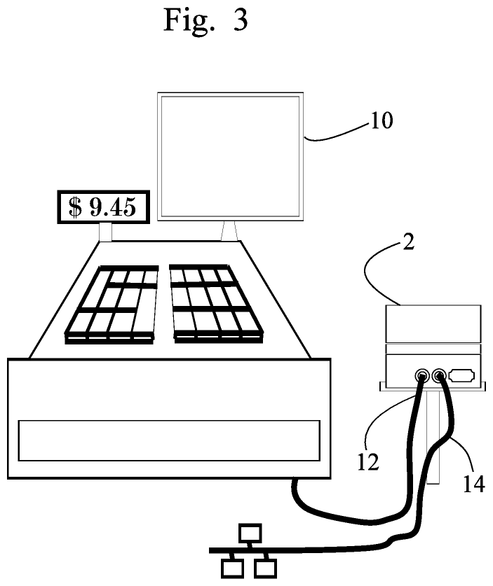

FIG. 3 is a frontal view of a POS station showing numeric display, keys, cash drawer, etc, and the back of the advanced finger scanner terminal (the finger scanner terminal faces toward customers rather than clerks, the back faces the sales associate).

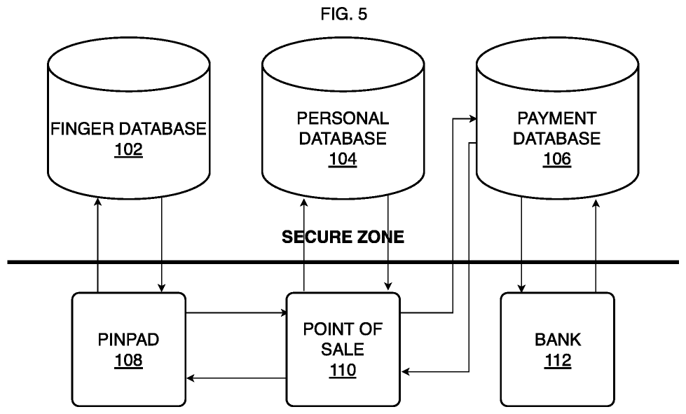

POS Station (cash register) 10 is as generally known in the market, and may have a cash drawer, a detailed display, a subtotal/total display, and so on. Finally, connection 12 may be a wireless RF connection for convenience, or may be a wired cable (as shown) for greater speed, accuracy, and security. A standard cable may be used if it meets the data bandwidth requirements of the advanced finger scanner, if so any useful cable standard may be used. For example, Ethernet or similar cable may be used for 14 so as to transmit secure data such as finger scans etc directly to the databases of the invention (see FIG. 5) for greater security. Note that the payment terminal has connections to both the POS station 10 and also to the banking payment system. Connection 14 may go directly to the banking system from the payment terminal, so payment terminal operations need not pass through the POS terminal in preferred embodiments. Thus it is important to note that the payment terminal may have connections not just to the POS station but to the financial settlement system (banking), to the various databases of the present invention and so on.

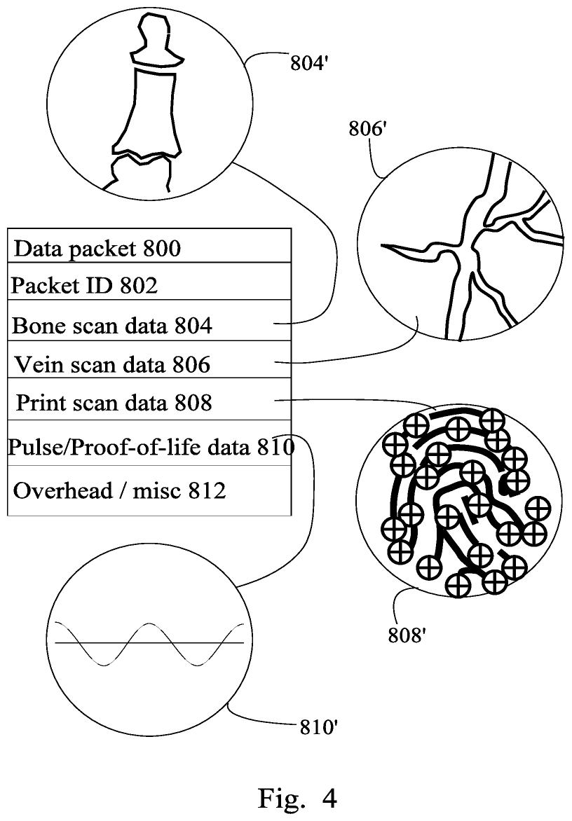

FIG. 4 is an advanced finger scan data return, showing the different data which the finger scan returns.

Data packet 800 may be a standardized packet carrying a number of different types of data, including purchase amount (in dollars or local currency), merchant ID, product purchased and so on, however, it may have fields for a number of new parameters necessitated by the present invention.

Packet ID 802 may have the double duty of identifying the fact that this is a finger deep scan package of data and thus identifying where it needs to be routed, or there may be a separate data field indicating the destination database for verification of the purchase.

Bone scan data 804 may contain numerical information generated by the deep scanner and the bone scan 804′ which the deep scanner/advanced scanner has produced. Note that the scan representation 804′ is not more “accurate” than the numerical data which might be found in field 804 of the data packet, rather, representation 804′ is a visualization which might be generated for the benefit of a human viewer, in this case a rather simplistic two dimensional representation similar to an x-ray. Even on this level a large number of biometric points may be generated, or simpler measurements (individual finger bone length, etc) may be substituted.

Biometric points of the finger bone structure are omitted for clarity.

Note that the data actually entered into field 804 will be encrypted for obvious reasons.

Vein scan data 806 may comprise another field in a data package 800. Again, this is shown in two dimensions for simplicity but need not be so constrained, and again in the visualization of the vein scan (806′) the biometric points have been omitted for clarity. Again, this data may be encrypted to prevent data fishing or man-in-the-middle type IT attacks. In general, one-way encryption algorithms may be preferable for this same reason: so that those intercepting the data packet 800 cannot simply replicate the encrypted version of the data. One simple way to provide this type of security would be a private key for encryption which is particular only to this particular merchant, POS station 10 or payment terminal 2, and which is of no use for decryption of the encrypted data, while the decryption key for this particular encryption key is not available at the merchant/POS/terminal and thus decryption can only be undertaken at the “vault” or “finger scan database” end of the communication chain.

This in turn leads to the conclusion that the optimal location for encryption is not the POS station, nor the merchant server, but in the terminal 2 (so that even connection 12 is not useful as an interception gateway, thus possibly allowing use of wireless RF connections from terminal to POS). If possible, the encryption should take place immediately at the deep scanner 8, so other parts of the terminal 2 never have unencrypted user finger deep scan data available.

These two readings by themselves would provide multi-factor (in this case, 2 factor) security, even without the additional optional use of a PIN, pass phrase or pass code memorized by the user. However, additional optional measurements may be taken to provide enhanced security: three, four, five factor security and so on.

A finger print scan 808′ may be taken and biometric points (shown in this case) may be used to generate an actual print scan data set 808, which as with the previous two factors is ideally encrypted instantly, in the scanner 8 or the terminal 2.

Print scan 808′ in this case is reasonably true to reality as a fingerprint, when pushed onto a flat surface, becomes a two dimensional physical object much like that pictured. (Lines and whorls have been simplified for clarity, biometric points have been included on this scan 808′, unlike the two previous scans). Note that biometric points may be ridges or valleys, pore structure, overall configurations (loop, whorl, double whorl, etc).

Pulse/proof of life data field 810 may contain a pulse reading, blood pressure, etc, which indicates that a pulse or other proof of life 810′ is present.

Finally overhead/miscellaneous field 812 stands in for the housekeeping necessary for proper transmission of the data packet 800, additional data (as mentioned previously, the amount to be spent, etc).

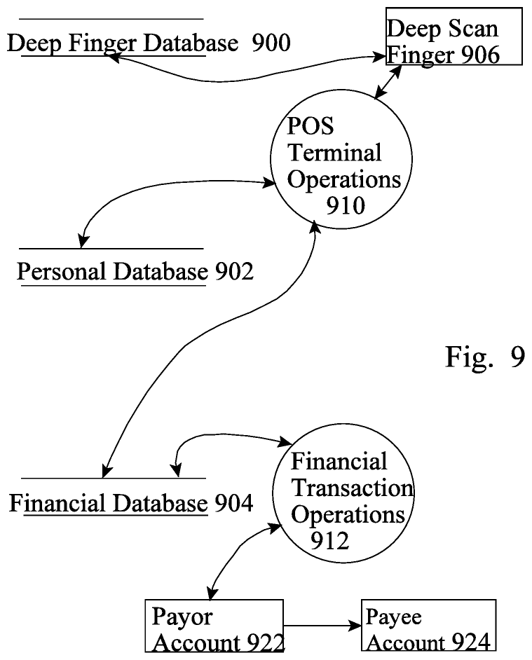

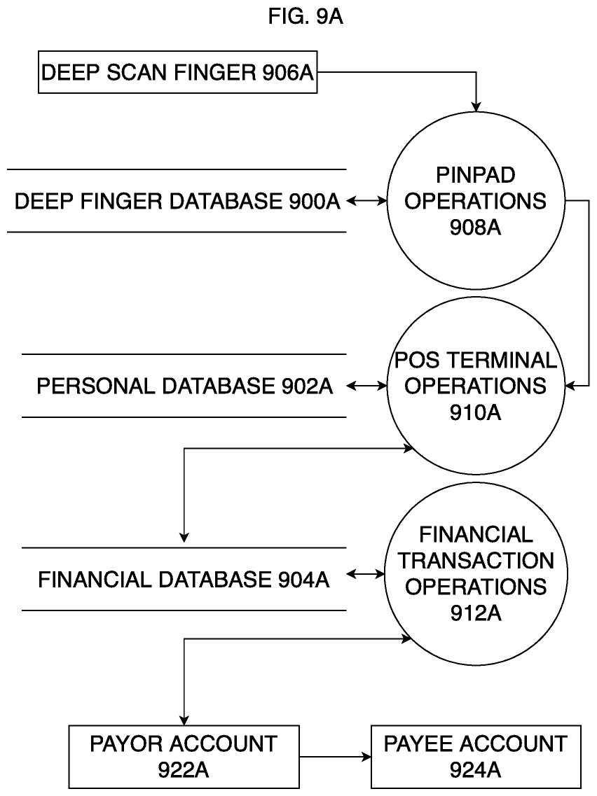

Further information about data flows may be found in the discussion of FIGS. 9 and 9A.

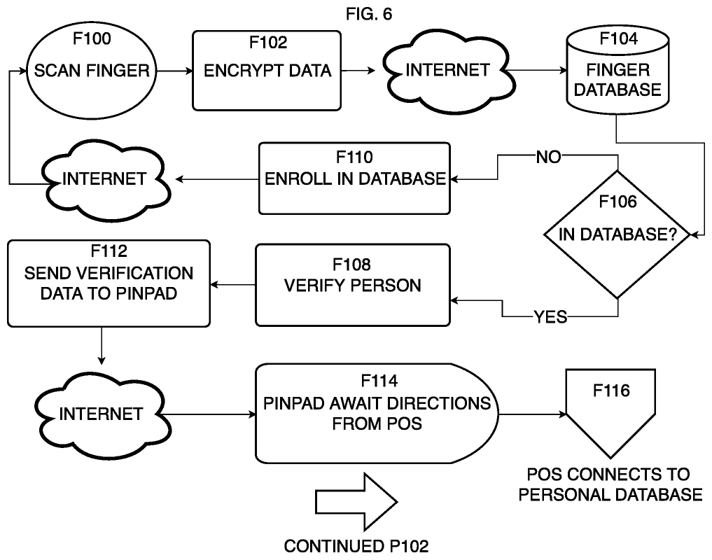

FIG. 5 is an overview structural diagram with data flows which further serves to connect the three following flowcharts (FIGS. 6, 7 and 8) for broader instantiations of the invention.

Finger deepscan database 102 in this embodiment communicates with the pinpad/advanced finger scanner/terminal 108. The pinpad 108 then communicates the successful purchase initiation to the POS station 110, which communicates with the personal database 104. The point-of-sale station 110 also communicates with the financial payment system, in particular, with a payment database 106 which then uses the financial system/banking system 112 to carry out the transaction.

In greater detail, FIG. 6 is a flowchart of an advanced fingerscan database and the usage thereof. Scan finger F100 is as discussed, then the immediate encryption of the data packet F102 and transmission to the finger database F104 follow. If at step F106 the scanned finger structures are found in the database, then the system clears the individual for purchase (F108) versus sending them to an enrollment process (F110).

Confirmation of the individual's account existence is sent to the pinpad/terminal at step F112, and the pinpad notifies the POS (F114) and goes into a wait cycle.

The POS then connects to the personal information database F116, and operation diagramming is continued on the next diagram.

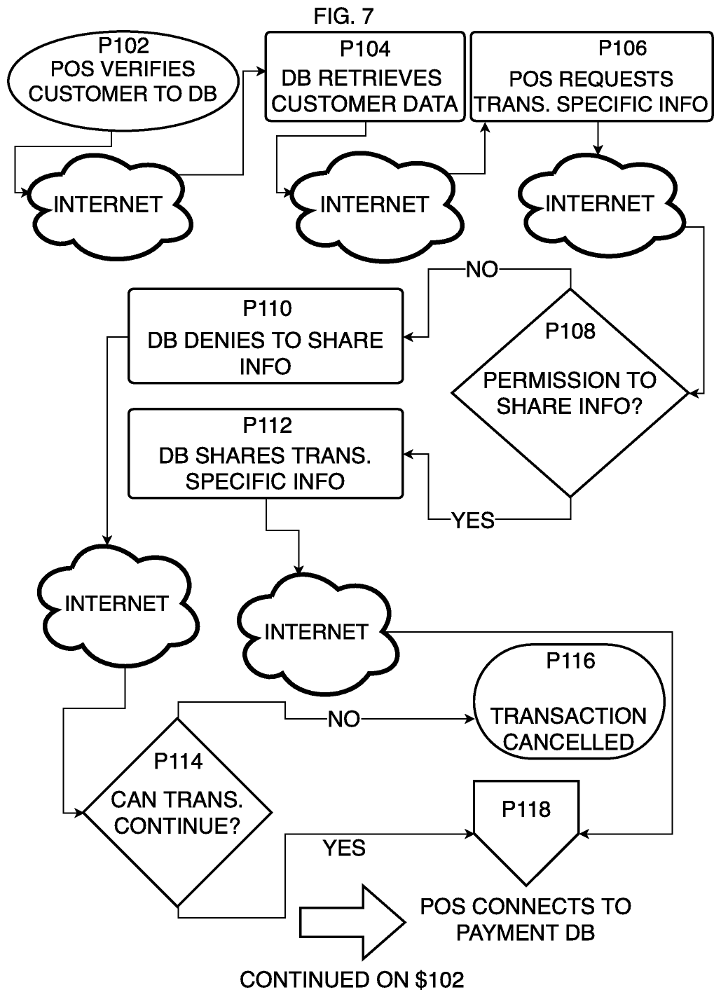

FIG. 7 is a flowchart of the operations when the advanced fingerscan is used to complete a financial transaction. The POS queries database for the specific customer (P102), and the database retrieves the appropriate customer data (P104) and returns it, after which the POS requests transaction specific info (P106) and the database must determine if the requested data has permission levels for sharing (P108). This may result in the database denial of sharing (P110) which may in turn result, if the lack of sharing is fatal to the transaction (P114) in the cancellation of the transaction (P116). It will be understood that this may be a privacy safeguard, etc.

Otherwise, the database shares the transaction specific info at step P112, or if the data is not shared but the transaction can continue (P114 discussed previously) then the POS station is notified and connects to the payment database (P118) which may itself be part of the overall financial transaction system.

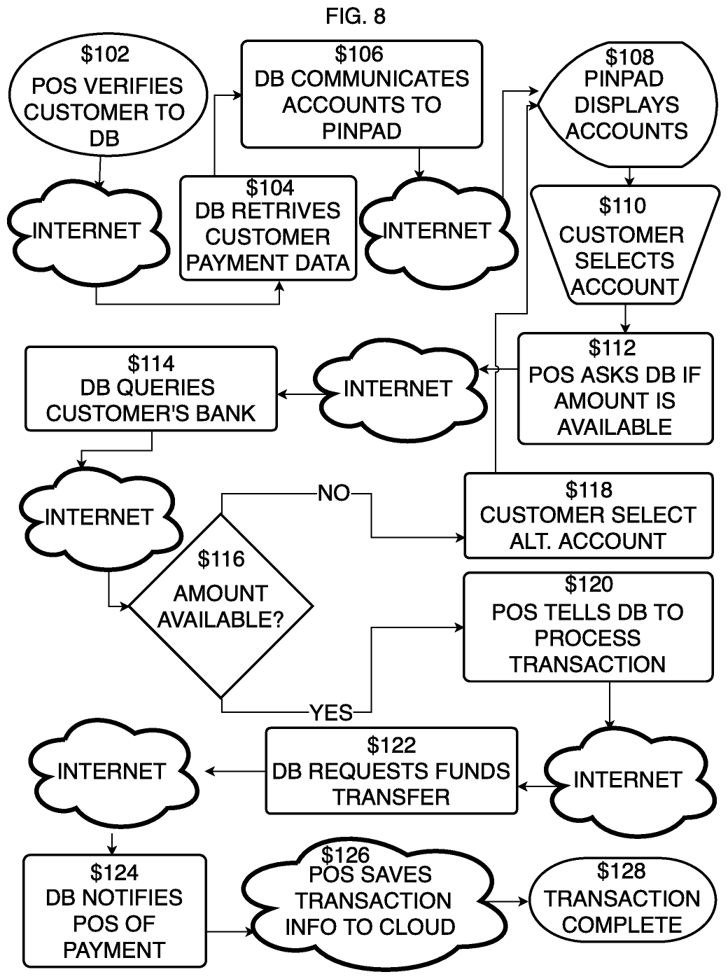

FIG. 8 is a flowchart of a personal information database and operations during completion of a financial transaction. At this stage of operations the POS first queries the financial database for the specific customer (S102) information and the database retrieves the customer payment data (S104), in particular, account information such as credit or money available, any restrictions, etc. The database communicates these accounts and their related information to the terminal at step S106, at which point the terminal is now functioning as a display and selection device. The terminal (pinpad) displays the various account choices (S108) which the customer has in the past registered with the system, and the customer selects from among their account choices (S110).

The POS queries the database for funds availability at step S112, the database in turn queries the customer's bank (S114) to determine if in fact the desired amount of money or credit is available, see step S116.

The customer selects one account choice or alternative (S118) for the withdrawal of funds or addition to credit, and then the POS tells the database and the overall banking system to process the transaction at step S120.

From here processes are as known: the database/system requests the funds transfer (S122), when it is completed the database notifies the POS of the payment (S124), the POS notifies the clerk and customer, possibly with the terminal or in another way. The POS then saves the transaction information to a cloud or other database (S126), and the transaction's completion is done, at step S128, with printing of receipts, physical transfer of goods and so on and so forth.

FIG. 9 is a Data Flow diagram. This diagram has 1 major physical input (the deep finger scan 906), three databases (or three parts of one database, cloud distributed databases and so on): the deep finger scans database 900, personal data fields/database 902 and the financial database 904. Finally there are in this less preferred embodiment only two major processes within the invention, which are the POS terminal operations, and the financial system operations 912.

Deep finger scan/scanner 906 generates data within the payment terminal and may in this alternative embodiment exchange data with the POS terminal and its operations 910. The POS operations include accessing the advanced finger scan database 900 (which decrypts the packet 800 discussed previously, compares the finger scan data and if it is verified, authorizes the financial transaction), and the personal data database 902, which contains the data of the individual(s) involved: name, contact information, credit rating or similar items.

Financial system operations 912 receives information from the financial database 904 (and optionally POS operations 910), and then provides data to the payor account 922, which in turn provides “data” (money transfer) to the payee account 924. This transfer of funds is the “output” of the data flow portion of the invention, and this transfer of funds is initiated by the advanced finger scan 906, which is the input to the data flow.

FIG. 9A is a data flow diagram of a preferred embodiment of the invention. In this embodiment there are three major processes occurring: payment terminal/pinpad operations (for example 908A), the POS terminal operations, and the financial system operations.

Deep finger scan/scanner 906A generates data within the payment terminal and thus initiates its operations 908A. The payment terminal operations include accessing the advanced finger scan database 900A (which decrypts the packet 800 discussed previously, compares the finger scan data and if it is verified, authorizes the financial transaction). The payment terminal operations 908A also communicate the verification of the customer with the POS operations 910A to continue the transaction. The POS or payment terminal operations may include accessing the personal data database 902A, which contains the data of the individual(s) involved: name, contact information, credit rating or similar items. Financial system operations 912A receives information from the financial database 904A (and optionally POS operations 910A or payment terminal operations 908A), and then provides data to the payor account 922A, which in turn provides “data” (money transfer) to the payee account 924A.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. An improved point-of-sale station, having a payment terminal, a first operative connection from the payment terminal to the point-of-sale station, and further having a second operative connection to a financial payment processing network, for use by customers having fingers having therein finger bone structure, veins, a pulse, and finger prints, wherein the improvement comprises:
an advanced finger scanner, the advanced finger scanner operative to scan such finger bone structure, encrypt the scan, and transmit the encrypted scan via the second operative connection to such financial payment processing network.

2. An improved point-of-sale station, having a payment terminal, a first operative connection from the payment terminal to the point-of-sale station, and further having a second operative connection to a financial payment processing network, for use by customers having fingers having therein finger bone structure, veins, a pulse, and finger prints, wherein the improvement comprises:
an advanced finger scanner, the advanced finger scanner operative to scan such finger veins, encrypt the finger vein scan, and transmit the encrypted finger vein scan via the second operative connection to such financial payment processing network.

3. An improved point-of-sale station, having a payment terminal, a first operative connection from the payment terminal to the point-of-sale station, and further having a second operative connection to a financial payment processing network, for use by customers having fingers having therein finger bone structure, veins, a pulse, and finger prints, wherein the improvement comprises:
an advanced finger scanner, the advanced finger scanner operative to scan such finger veins, scan such finger bone structure, encrypt the finger vein scan and the finger bone structure scan, and transmit the encrypted scans via the second operative connection to such financial payment processing network.

4. The improved point-of-sale station of claim 3, further comprising:
the advanced finger scanner further operative to determine the existence of such pulse, flag the existence of such pulse, and transmit the pulse existence flag, along with the encrypted finger vein scan and the encrypted finger bone structure scan via the second operative connection to such financial payment processing network.

5. The improved point-of-sale station of claim 4, further comprising:
the advanced finger scanner further operative to scan such fingerprint, encrypt the fingerprint scan and transmit the encrypted fingerprint scan, along with the pulse existence flag, the encrypted finger vein scan and the encrypted finger bone structure scan via the second operative connection to such financial payment processing network.

6. A point-of-sale station for use with a financial payment processing network, for use by customers having fingers having therein finger bone structure, veins, a pulse, and finger prints, wherein the point-of-sale station comprises:
a payment terminal;
a first operative connection from the payment terminal to the point-of-sale station,
a second operative connection to such financial payment processing network;
the payment terminal operative to initiate a financial payment using such financial payment processing network, by transmitting a first data packet to such financial payment processing network via the first and second operative connections and the point-of-sale station;
the payment terminal having an advanced finger scan scanner operative to determine the existence of such pulse and flag the existence of such pulse;
the advanced finger scanner further operative to scan one member selected from the group consisting of: such finger bone structure, such finger veins, or both, and encrypt the scan;
the payment terminal operative to create the first data packet by combining the encrypted scan and the flag and transmit the first data packet;
whereby the financial payment is initiated.

7. The point-of-sale station of claim 6, wherein the advanced finger scanner is further operative to scan such fingerprint and encrypt the scan;
and wherein the payment terminal is further operative to incorporate into the first data packet the encrypted fingerprint scan.

8. The point-of-sale station of claim 7, further comprising:
an advanced finger scan database, having a third operative connection to such financial payment processing network, the advanced finger scan database operative to respond to receipt of the first data packet by verifying that the first data packet matches a first record of the advanced finger scan database;
the first record having at least three parts, a personal information part, a financial information part, and an advanced finger scan record part.
